(19) United States
(12) Patent Application Publication
(10) Pub. No.: US 2026/0286928 A1
(43) Pub. Date: Sep. 24, 2026

(54) Hydrostatic Rotary Machine Having Pins That Engage Grooves of a Cam Ring

(71) Applicant: Robert Bosch GmbH, Stuttgart (DE)

(72) Inventors: Evangelos Rompogiannakis, Glasgow (GB); Adam MacPhee, Kircaldy (GB); Carlos Tellez, Peth (GB); Frank O'Hara, Auchtermuchty (GB); Furqan Shahzad, Edinburgh (GB); Johann Praeffcke, Scotlandwell (GB); Laurent Eugene Albert, Frignicourt (FR)

(21) Appl. No.: 19/571,242

(22) Filed: Mar. 18, 2026

(30) Foreign Application Priority Data
Mar. 19, 2025 (DE) 10 2025 110 622.3

(51) Int. Cl. F03C 1/30; F03C 1/047

(52) U.S. Cl. CPC F03C 1/0409; F03C 1/047

(57) ABSTRACT

A hydrostatic rotary machine includes a stator and a rotor, which are coaxial with an axis of rotation and rotatable relative to one another, a plurality of pistons linearly movably received in the rotor, and a cam track arranged on a separate cam ring in a main body of the stator surrounding the rotor. A plurality of pins are fixedly received in a respective assigned first recess in the main body, and the pins each engage in a corresponding second recess arranged radially outside on the cam ring. The cam ring has first and second end faces, which point in opposite directions with respect to the axis of rotation. The second recesses are each formed as a groove extending in the direction of the axis of rotation, and all of the grooves are open towards the first end face and open radially outward with respect to the axis of rotation.

This application claims priority under 35 U.S.C. § 119 to application no. DE 10 2025 110 622.3, filed on Mar. 19, 2025 in Germany, the disclosure of which is incorporated herein by reference in its entirety.

The disclosure relates to a hydrostatic rotary machine.

### BACKGROUND

A hydrostatic rotary machine in the form of a radial piston motor is known from EP 3 818 266 B1. The hydrostatic rotary machine has a stator in which a rotor is rotatably received relative to an axis of rotation. A plurality of pistons are received in the rotor that are radially movable to the axis of rotation. During operation, the pistons abut a cam track that extends in a wave-like manner around the axis of rotation. The cam track is arranged on a separate cam ring, which is surrounded by a main body of the stator. The cam ring is secured against rotation relative to the main body with respect to the axis of rotation by means of a plurality of pins. The drawback of this design is the difficult rotational alignment of the cam ring relative to the main body during pressing of the cam ring into the main body. If the bores for the pins are made prior to pressing, this alignment must be very accurate so that the pins can be installed with virtually no play. If the aforementioned bores are produced after pressing, high alignment accuracy between the cam ring and the main body is not required, but the production of the bores is complex and expensive.

### SUMMARY

An advantage of the present disclosure is that the alignment of the cam ring is simplified when installing in the main body. Furthermore, the pins can be made significantly more solid, so that fewer pins are required. The space requirement of the hydrostatic rotary machine is lower than that of the known hydrostatic rotary machine with the same torque capacity.

According to disclosure, it is proposed that the second recesses are each configured in the form of a groove extending in the direction of the axis of rotation, wherein all of the aforementioned grooves are open towards the first end face and open radially outward with respect to the axis of rotation. The cam ring and/or the main body are preferably integrally formed. The main body preferably surrounds the cam ring, wherein the cam ring abuts an inner circumferential surface of the main body. The pistons are preferably radially, in particular vertically, linearly movable relative to the axis of rotation. The cam track preferably points towards the axis of rotation. It preferably extends with a constant cross-sectional shape along the axis of rotation. The second recesses together with the pins are preferably arranged uniformly around the axis of rotation. Preferably, a plurality of pins are provided, which are arranged most preferably uniformly distributed around the axis of rotation.

It may be provided that all grooves are configured closed towards the second end face. This results in a particularly stable cam ring.

It may be provided that all pins and all grooves are identical to one another. The corresponding hydrostatic rotary machine is particularly inexpensive to manufacture. There is no possibility of mixing up the pins during assembly. It is to be understood that different pins and/or different grooves are also usable. This may be required, for example, if insufficient installation space is available on the stator for a pin.

It may be provided that the cam track extends in a wave-like manner around the axis of rotation with a plurality of periods, so that the pistons perform a plurality of strokes corresponding to the number of said periods when the rotor performs one revolution relative to the axis of rotation, wherein the second recesses are arranged in a circumferential direction relative to the axis of rotation exclusively in the areas in which the cam track has a minimum distance from the axis of rotation. The areas of the cam ring in which the distance between the cam track and the axis of rotation is a maximum can thus be designed with a particularly small wall thickness. Subsequently, the overall hydrostatic rotary machine requires less installation space. Furthermore, the material demand for the cam ring, which preferably consists of a high-quality steel, decreases so that the cam track has a high strength. With the design according to the disclosure, fewer and more solid pins can be used compared to EP 3 818 266 B1.

It may be provided that the main body is configured in the area of the cam ring and in the circumferential direction relative to the axis of rotation between the first recess in a rotationally symmetrically manner relative to the axis of rotation, such that it defines a minimum first wall thickness in the radial direction relative to the axis of rotation, wherein the cam ring defines a minimum second wall thickness relative to the axis of rotation in the area of the cam track, wherein the first wall thickness is greater than the second wall thickness. A corresponding hydrostatic rotary machine requires little installation space, yet can withstand the high torques occurring during operation. In the direction of the axis of rotation directly adjacent to the first recesses, the main body preferably has at least one section which is entirely rotationally symmetrical with respect to the axis of rotation. There, the main body has the minimum first wall thickness over its entire circumference.

It may be provided that the first recesses each comprise a first section, which is circularly cylindrical with respect to a cylinder axis, wherein the first recesses are each open at a radially inner end, wherein the respective associated pin protrudes from the relevant first recess at this point, wherein the cam ring abuts the main body with a press fit extending in the direction of the axis of rotation over a first area, wherein the cam track extends in the direction of the axis of rotation over a second area, wherein the first region is arranged entirely within the second area. As the first area is short in the direction of the axis of rotation, it is particularly easy to press the cam ring into the main body. Because of the pins according to the disclosure, its position is nonetheless reliably secured. The first recesses are preferably identical to one another, wherein the cylinder axes are arranged in a common plane that is aligned perpendicular to the axis of rotation. The cylinder axes preferably each intersect the axis of rotation at a right angle. At a radially inner end, the first recesses are preferably provided with a first countersink, which is most preferably of a frustoconical shape. The first recesses preferably intersect the main body in the radial direction with respect to the axis of rotation. The first recesses are preferably provided with a second countersink at the radially outer end, which is most preferably configured as a flat countersink. The first recesses are preferably formed exclusively from the first section and from the first and second countersinks.

It may be provided that the first recesses each comprise a first section, which is circularly cylindrical with respect to a cylinder axis, such that it defines a first diameter, wherein the respective associated pin comprises a second section and a third section, which each abut the first section at least in sections, wherein the second section is circularly cylindrical with respect to the cylinder axis with a second diameter, wherein the third section is circularly cylindrical relative to the cylinder axis with a third diameter, wherein the second diameter is greater than the third diameter. Preferably, there is a press fit with the first section only in the area of the second section. This press fit prevents the pin from moving out of the first recess. In the context of the assembly of a pin, preferably the third section is first inserted into the first recess, wherein the second section is subsequently inserted into the first recess. This simplifies the assembly of the pin because a lower assembly force is required at the start of assembly, i.e., if the pin is not yet guided from the first recess. In the area of the third section, there is preferably a transition fit with the first section.

It may be provided that the third section is arranged radially further outward than the second section. The corresponding pin is preferably mounted from the inside on the main body. This first embodiment of the disclosure is preferred when the pistons perform only a few strokes per revolution of the rotor so that a large first diameter can be selected. In the first embodiment, it is contemplated that the first recesses are closed radially outward, wherein they are delimited solely by the integral main body. This means that there is no risk of leakage in this area, and the sealing ring described below is not required. However, a first recess that intersects the main body in a radial direction is more cost-effective to produce, as it can be easily drilled from the outside.

It may be provided that, in the area of the third section, a sealing ring is arranged between the pin and the respective associated first recess. This reliably and easily prevents hydraulic fluid from leaking from the main body in the area of the pins. The first recess preferably intersects the main body in the radial direction with respect to the axis of rotation. The aforementioned sealing ring is preferably received in an adjusted ring groove in the relevant pin, wherein the ring groove divides the relevant third section into two separate sub-sections. It is at least conceivable to provide an annular groove for the sealing ring on the first section and thus on the main body. However, this is complex and expensive.

It may be provided that the second section is arranged radially further outward than the third section, wherein the first recess intersects the main body radially with respect to the axis of rotation. Such a pin is preferably mounted on the main body from the outside. In this second embodiment of the disclosure, the assembly forces are analogous to those in the first embodiment. The second embodiment is preferred when the pistons perform many strokes per revolution of the rotor so that only a small first diameter can be selected.

It may be provided that the first recesses are each radially sealed on the outside by a separate flat seal, which is attached to the main body by a separate retaining plate. The second embodiment is preferably used when the pins have a small diameter that makes it difficult to use a sealing ring. The flat seal and the retaining plate are preferably each formed in the form of a planar plate of constant thickness, wherein they most preferably have the same outer outline. The retaining plate is preferably fixed to the main body with at least two screws.

It may be provided that either the second or the third section projects radially inward over the main body, the respective groove having two opposite side walls aligned parallel to the cylinder axis. The aforementioned side walls are configured parallel to the axis of rotation because the groove extends in the direction of the axis of rotation. The groove and the respective pin are preferably matched to one another in such a way that they can preferably contact exclusively in the area of the planar side walls. The distance of the side walls is preferably adapted to the second or the third diameter with little play. The free end of the pin may be provided with a chamfer or a radius, wherein the bottom of the associated groove may be rounded. The aforementioned chamfer or the aforementioned radius and the aforementioned fillet are preferably matched to one another in such a way that there is a distance between the groove and the pin.

It may be provided that the cam ring on the second front face is provided with an annular extension relative to the axis of rotation, wherein the cam track ends in the direction of the axis of rotation away from the extension. During the installation of the cam ring in the main body, a retaining device can be attached radially inside the annular extension, with which the cam ring is inserted into the main body, wherein the aforementioned retaining device can in particular be used to apply the mounting forces to the cam ring to produce the press fit to the main body discussed above. The corresponding pressing forces are preferably introduced into the cam ring at the end face of the annular extension in order to minimize elastic deformation of the cam ring during pressing. The second end face is preferably configured planar and perpendicular to the axis of rotation away from the annular extension.

It may be provided that a first outer diameter of the annular extension is greater than a second outer diameter of the remaining cam ring, wherein the main body is configured in the area of the first outer diameter at a distance to the cam ring. The second outer diameter is preferably precisely machined so that the desired pressing between the cam ring and the main body is achieved. The first outer diameter preferably forms a rough dimension of the cam ring, from which the second outer diameter is produced. Due to the aforementioned distance, the desired press fit is nevertheless limited to the second outer diameter. During the production of the second outer diameter, the cam ring may be clamped to the outside of the annular extension.

Of course, the above-mentioned features and those to be explained below can be used not only in the combination indicated in each case, but also in other combinations or on their own, without going beyond the scope of the present disclosure.

### BRIEF DESCRIPTION OF THE DRAWINGS

The disclosure is explained in more detail below with reference to the enclosed drawings. The figures show:

FIG. 1 a longitudinal section of a hydraulic rotary machine according to a first embodiment of the disclosure;

FIG. 2 an enlarged detail of FIG. 1 in the area of a pin;

FIG. 3 a longitudinal section of a pin;

FIG. 4 a perspective view of the first end face of the cam ring;

FIG. 5 a perspective view of the second end face of the cam ring;

FIG. 6 a partial cross-section of the hydrostatic rotary machine of FIG. 1;

FIG. 7 a perspective view of a hydraulic rotary machine according to a second embodiment of the disclosure; and

FIG. 8 a view analogous to FIG. 2 of the hydrostatic rotary machine according to the second embodiment.

### DETAILED DESCRIPTION

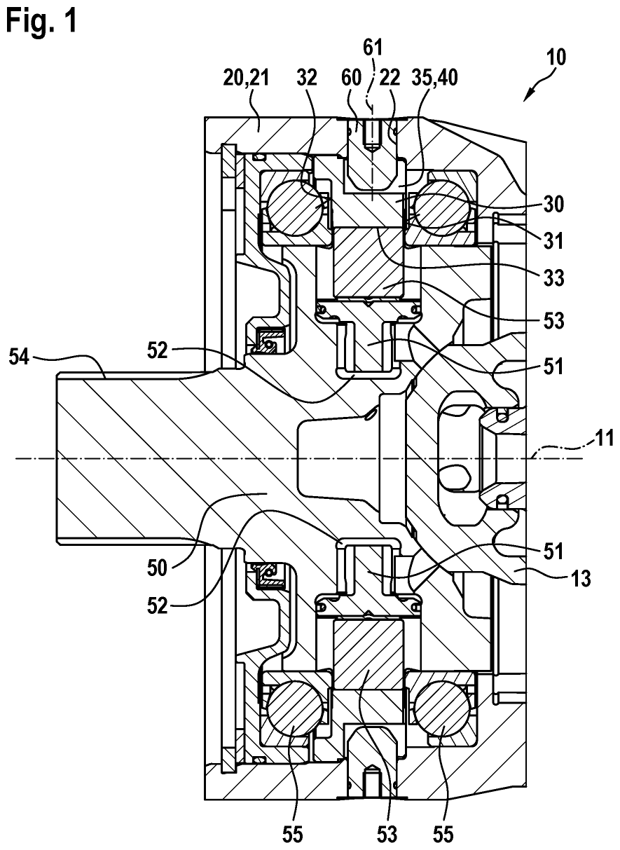

FIG. 1 shows a longitudinal section of a hydrostatic rotary machine 10 according to a first embodiment of the disclosure. The section plane includes the axis of rotation 11 and the cylinder axes 61. The hydrostatic rotary machine 10 comprises a stator 20 and a rotor 50. The rotor 50 is rotatably supported on the stator 20 by means of two pivot bearings 55 with respect to an axis of rotation 11. In the present case, the pivot bearings 55 are configured as rolling bearings, in particular as angular contact ball bearings. In the rotor 50, a plurality of, in the present case eight, pistons 51 are received radially in a linearly movable manner to the axis of rotation 11, such that they together with the rotor 50 each limit an associated cylinder space 52. The volume of a cylinder space 52 changes as the respective piston 51 moves. The pistons 51 each comprise a rotatable roller 53 that abuts a cam track 33 of the stator 20 during operation of the hydrostatic rotary machine 10. The cam track 33 extends in a wave-like manner with several periods around the axis of rotation 11, such that the pistons 51 perform several strokes during one revolution of the rotor 50.

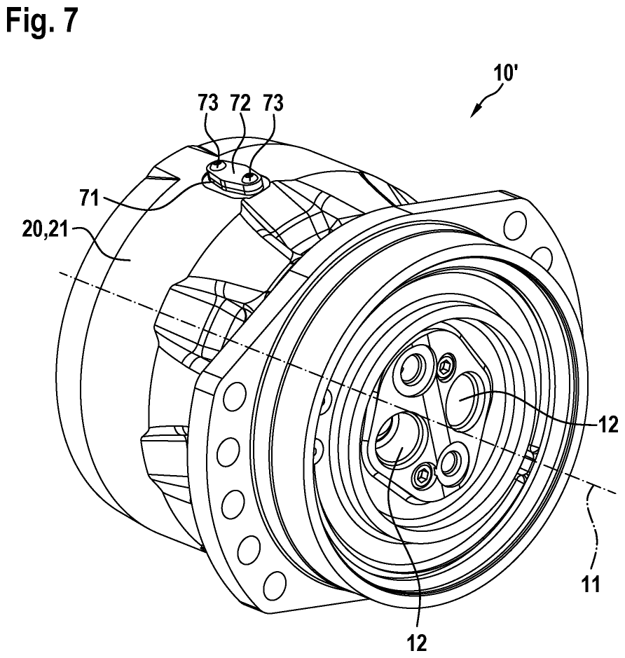

The stator 20 comprises a main body 21, a cam ring 30, and a fluid distributor 13. The fluid distributor 13 establishes the connection between the cylinder spaces 52 and the working connections (#12 in FIG. 7) on the stator 20 in the manner that rotation of the rotor 50 is associated with fluid exchange between the two working connections. The fluid is preferably hydraulic oil. The rotor 50 protrudes from the stator 20 with a drive pin 54. The present hydrostatic rotary machine 10 is preferably used as a radial piston motor, for example as a wheel drive for a mobile work machine.

The integral main body 21 completely surrounds the integral cam ring 30, wherein the cam ring 30 abuts an inner circumferential surface of the main body 21, preferably with a press fit. In order for the cam ring 30 to not move due to the very high torques achievable with such a hydrostatic rotary machine 10, it is secured against twisting with a plurality of pins 60 about the axis of rotation 11 relative to the main body 21. The pins 60 are each fixedly mounted in a respective associated first recess 22 of the main body 21, wherein they are in particular pressed therein. They protrude radially inward relative to the axis of rotation 11 above the main body 21, each of which is submerged into an adjusted second recess 35 of the cam ring 30. The cam ring 30 has a first end face 31 and a second end face 32, which face point toward opposite directions relative to the axis of rotation 11. The second recesses 35 are each configured in the form of a groove 40, which is open towards the first end face 31, wherein it is preferably closed towards the second end face 32. Thus, the cam ring 30 can be installed in the main body 21 after the pins 60 are mounted. As a result, a correct angular alignment of the cam ring 30 relative to the main body 21 with respect to the axis of rotation 11 is ensured. In FIG. 1, the assembly of the cam ring 30 takes place from the left. The aforementioned grooves 40 are also open radially outward with respect to the axis of rotation 11.

The pins 60 are configured in a rotationally symmetrically manner with respect to a respective associated cylinder axis 61, which is aligned radially to the axis of rotation 11. The cylinder axes 61 preferably intersect the axis of rotation 11 at right angles.

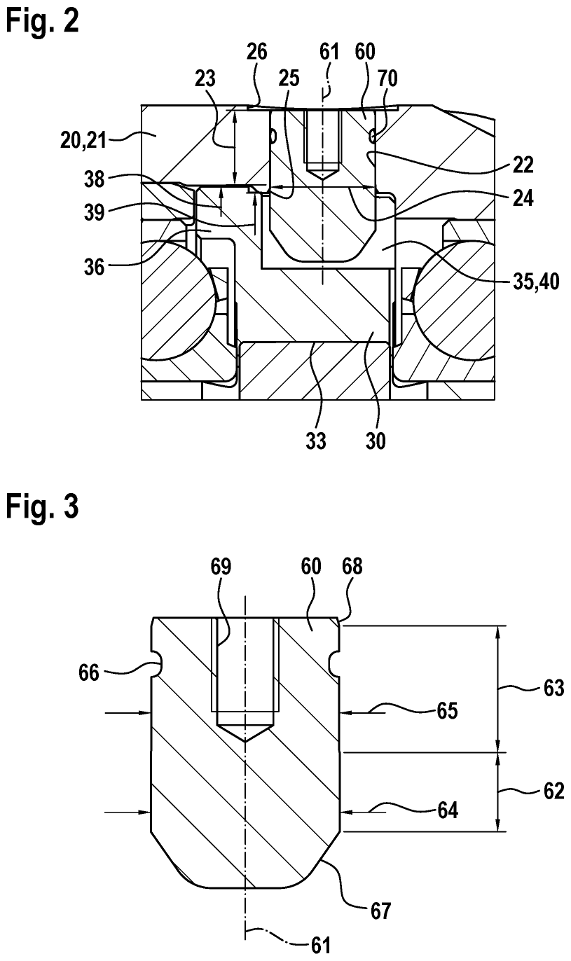

FIG. 2 shows an enlarged detail of FIG. 1 in the area of a pin 60. The first recess 22 intersects the main body 21 in the direction of its cylinder axis 61. It is largely circular cylindrical with a first diameter 24 relative to the cylinder axis 61. The circular cylindrical shape defines a first section 23 of the first recess 22. Radially inward, the first recess 22 is provided with a first countersink 25, which in the present case is configured as a conical countersink. Radially outward, the first recess 22 is provided with a second countersink 26, which in the present case is configured as a flat countersink.

In FIG. 2, the annular extension 36 can further be seen on the cam ring 30, which extends towards the axis of rotation (no. 11 in FIG. 1) on the second end face 32. In the area of the annular extension 36, the cam ring 30 has a first outer diameter 38 that is greater than a second outer diameter 39 of the cam ring 30. In the area of the second outer diameter 39, the cam ring 30 is compressed with the main body 21. In contrast, the main body 21 is configured in the area of the larger first outer diameter 38 at a distance to the cam ring 30, so that no pressing takes place therein. The width in the direction of the axis of rotation 11, at which the second outer diameter 39 is present, is designed somewhat smaller than the corresponding width of the cam track 33.

FIG. 3 shows a longitudinal section of a pin 60, wherein the section plane contains the respective cylinder axis 61. The pin 60 has a second section 62 that is circularly cylindrical with respect to the cylinder axis 61 with a second diameter 64. It further has a third section 63 formed with a third diameter 65 that is circularly cylindrical relative to the cylinder axis 61. The second section 62 and the third section 63 are directly adjacent to each other, with the second diameter 64 being slightly larger than the third diameter 65, such that there is a press fit in the second section 62 to the first recess (no. 22 in FIG. 2), with a transition fit preferably being present in the third section 63.

In the first embodiment shown in FIG. 3, the radially inwardly arranged first chamfer 67 is located on the second section 62. A thread 69 is provided on the end side of the third section 63 located on the radial outside, wherein a second chamfer 68 smaller than the first chamfer 67 is also provided. The thread 69 is for mounting the pin 60 in the first recess (#22 in FIG. 2). The pin 60 is inserted from the inside of the main body into the first recess, which preferably intersperses the main body as shown in FIG. 2. As long as there is only one engagement with the third section 63, this is possible with a low mounting force. Once the second section 62 engages with the first recess, the mounting force increases. The mounting force is then applied, for example, by screwing a screw into the thread 69, wherein the head of the screw supports at least indirectly on the outside of the main body, in particular on the second countersink (no. 26 in FIG. 2).

In the third section 63, there is provided an annular groove 66 for receiving a sealing ring (no. 70 in FIG. 2). This reliably prevents liquid from exiting the hydrostatic rotary machine in the area of a pin 60.

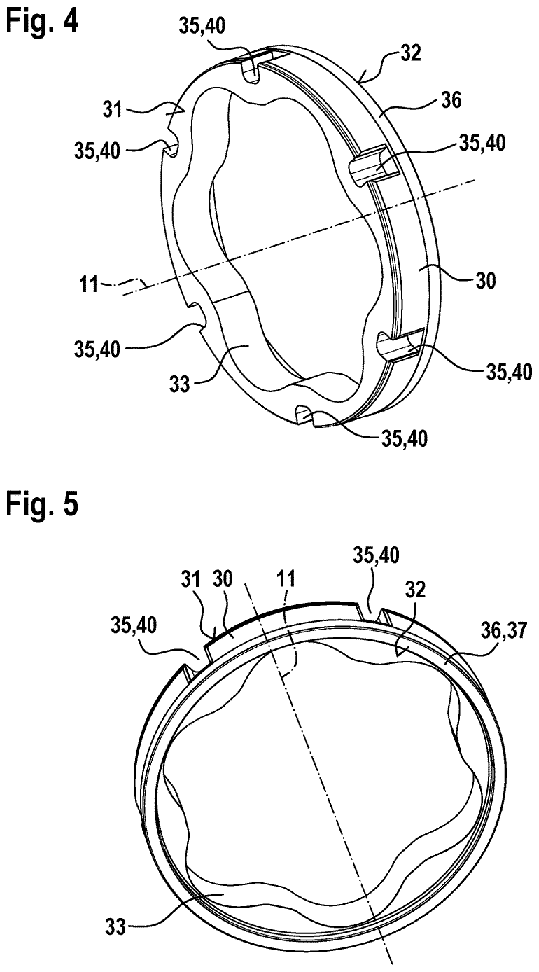

FIG. 4 shows a perspective view of the first end face 31 of the cam ring 30. The cam ring 30 extends annularly around the axis of rotation 11. On its inner side, it is provided with a cam track 33, which extends along the axis of rotation 11 with a constant cross-sectional shape. The aforementioned cross-sectional shape is designed in a wave-like manner with six periods in the present case. Accordingly, a piston 51 performs six strokes while the rotor 50 performs a full revolution relative to the axis of rotation 11.

On its outside, the cam ring 30 is provided with the second recesses 35, which are configured in the form of grooves 40. The grooves 40 are open towards the first end face 31, and are closed towards the second end face 32. The grooves 40 are also open radially outward, so that the respective associated pin 60 can engage from there. In the area of the grooves 40, the cam ring 30 with a second outer diameter 39 is circularly cylindrical relative to the axis of rotation 11. Directly thereafter, it has a somewhat larger first outer diameter 38, wherein the annular extension 36 is provided there.

The first end face 31 is planar, wherein it is aligned perpendicular to the axis of rotation 11.

In FIG. 4 it can further be seen that the number of second recesses 35 corresponds to the number of periods of the cam track 33. It can further be seen that the second recesses 35 are each arranged in the areas in which the cam track 33 has a minimum distance 34 from the axis of rotation 11.

FIG. 5 shows a perspective view of the second end face 32 of the cam ring 30. The annular extension 36 is arranged on the second end face 32 and protrudes in the direction of the axis of rotation 11 beyond the remaining second end face 32. The inner circumferential surface of the annular extension 36 is circularly cylindrical with respect to the axis of rotation 11. There, for example, the cam ring 30 can be clamped to machine the outer peripheral surface of the cam ring 30 or to insert the cam ring 30 into the main body 21.

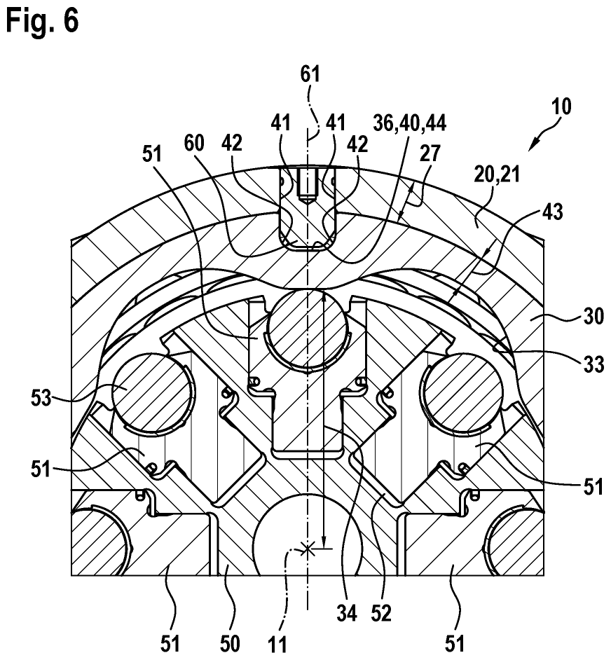

FIG. 6 shows a partial cross-section of the hydrostatic rotary machine 10 of FIG. 1. The sectional plane is aligned perpendicular to the axis of rotation 11 wherein it includes the cylinder axes 61. It can first be seen that the pistons 51 are arranged uniformly distributed around the axis of rotation 11, wherein they are radially movable relative to the axis of rotation 11. The pistons 51 are shown in the maximum retracted position, wherein during operation of the hydrostatic rotary machine 10, their rollers 53 abut the cam track 33.

In the area of the pin 60, the main body 21 has a first wall thickness 27, which is greater than a second wall thickness 43 of the cam ring 30. The second wall thickness 43 of the cam ring 30 is the minimum wall thickness of the cam ring 30, which is present at the locations where the cam track 33 has its maximum distance from the axis of rotation 11. With this design, the pin 60 can be pressed into the main body 21 with high strength while the hydrostatic rotary machine 10 still requires little installation space.

It can further be seen in FIG. 6 how the pin 60 interacts with the associated groove 40. In particular, it can be seen that the pin 60 abuts the associated planar side walls 41 of the groove 40 exclusively in its circular cylindrical area. In the area of its first chamfer 67, it is arranged at a distance to the groove 40, in particular to the fillet therein 42, so that power transmission is not possible there.

The bottom 44 of the groove 40 is level with it being aligned perpendicular to the cylinder axis 61. The transition between the planar side walls 41, which are aligned parallel to the cylinder axis 61 and the bottom 44 is provided with a circular fillet 42 in each case.

FIG. 7 shows a perspective view of a hydrostatic rotary machine 10′ according to a second embodiment of the disclosure. The second embodiment is identical to the first embodiment except for the differences described below, and therefore reference is made in this regard to the statements on FIGS. 1 to 6. In FIGS. 1 to 8, the same or corresponding parts are provided with the same reference numerals. The external shape of the hydrostatic rotary machine 10′, including the working connections 12 shown in FIG. 7 is also present in the first embodiment, with differences in the area of the retaining plate 72 alone.

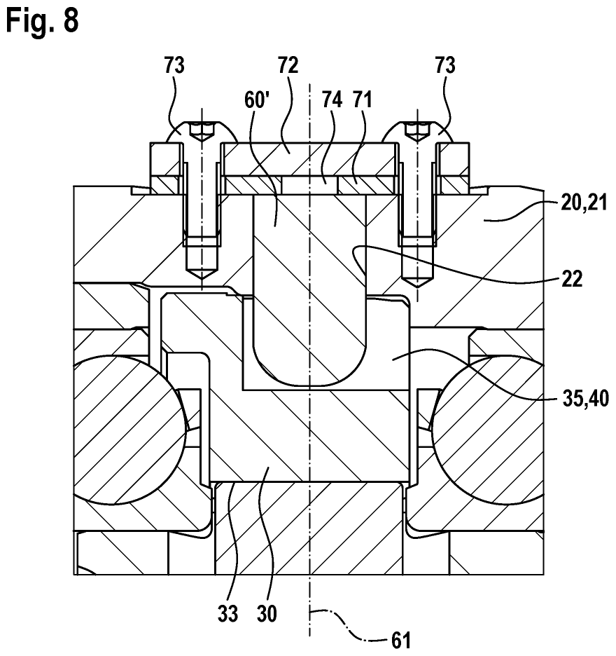

In the second embodiment, pins (no. 60′ in FIG. 8) are used, which are installed in the main body 21 from the outside. These pins also have a slightly smaller diameter than those of the first embodiment.

The bolts 73 that clamp the retaining plate 72 against the flat seal 71 may also be used to assemble the pins 60. Here, the pin can be pushed into the first recess (no. 22 in FIG. 8) with a more solid mounting body comparable to the retaining plate 72 until its outer end face is flush with the outer surface of the main body 21. The flat seal 71 is then clamped against the main body 21 with the retaining plate 72 to seal the corresponding location.

FIG. 8 shows a view of the hydrostatic rotary machine 10′ according to the second embodiment, analogous to FIG. 2. The flat seal 71 and the retaining plate 72 are each embodied as flat plates of constant thickness with the same outer outline (see FIG. 7). For example, the retention plate 72 is made of steel, with the flat seal 71 being made of, for example, an elastomer. Concentric to the cylinder axis 61, the flat seal 71 is provided with a breakthrough 74 such that the sealing action in the area of contact between pin 60′ and first recess 22 is particularly good.

The two bolts 73 each intersect the retaining plate 72 and the flat seal 71, respectively, and are screwed into the main body 21. The retaining plate 72 and flat seal 71 together with the bolts 73 are formed in a mirror-symmetrical manner with respect to a plane containing the cylinder axis 61, preferably with the said plane aligned perpendicular to the axis of rotation (no. 11 in FIG. 7).

### REFERENCE SIGNS

10 Hydrostatic rotary machine (first embodiment)
10′ Hydrostatic rotary machine (second embodiment)
11 Axis of rotation
12 Working connection
13 Fluid distributor
20 Stator
21 Main body
22 First recess
23 First section
24 First diameter
25 First countersink
26 Second countersink
27 First wall thickness
30 Cam ring
31 First end face
32 Second end face
33 Cam track
34 Minimum distance of the cam track to the axis of rotation
35 Second recess
36 Annular extension
37 End face of the annular extension
38 First outer diameter
39 Second outer diameter
40 Groove
41 Side wall
42 Fillet
43 Second wall thickness
44 Base
50 Rotor
51 Piston
52 Cylinder space
53 Roller
54 Drive pin
55 Rotary bearing
60 Pin (first embodiment)
60′ Pin (second embodiment)
61 Cylinder axis
62 Second section
63 Third section
64 Second diameter
65 Third diameter
66 Annular groove
67 First chamfer
68 Second chamfer
69 Thread
70 Sealing ring
71 Flat seal
72 Retaining plate
73 Screw
74 Breakthrough

1. A hydrostatic rotary machine comprising:
a stator comprising a cam track;
a rotor, the stator and the rotor being coaxial with respect to an axis of rotation and rotatable relative to one another;
a plurality of pistons linearly movably received in the rotor such that, together with the rotor, the plurality of pistons delimit a respective associated cylinder space, the plurality of pistons configured to interact with the cam track in such a way that rotational movement of the rotor is associated with a stroke movement of the pistons,
a separate cam ring on which the cam track is arranged, the cam ring being received in a main body of the stator so as to surround the rotor
at least one pin fixedly received in a respective associated first recess in the main body, the at least one pin engaging in an adapted second recess, which is arranged radially outside on the cam ring,
wherein the cam ring has a first end face and a second end face, which point in opposite directions with respect to the axis of rotation,
wherein the second recesses are each configured as a groove extending in a direction of the axis of rotation, and
wherein all of the grooves are open towards the first end face and open radially outward with respect to the axis of rotation.

2. The hydrostatic rotary machine according to claim 1, wherein all of the grooves are closed towards the second end face.

3. The hydrostatic rotary machine according to claim 1, wherein all pins of the at least one pin and all grooves are identical to one another.

4. The hydrostatic rotary machine according to claim 1, wherein:
the cam track extends in a wave-like manner around the axis of rotation with a plurality of periods, so that the pistons perform a plurality of strokes corresponding to a number of said plurality of periods when the rotor performs one revolution relative to the axis of rotation, and
the second recesses are arranged in a circumferential direction relative to the axis of rotation exclusively in areas in which the cam track has a minimum distance from the axis of rotation.

5. The hydrostatic rotary machine according to claim 4, wherein:
the main body is configured in an area of the cam ring and in the circumferential direction relative to the axis of rotation between the first recess in a rotationally symmetrically manner relative to the axis of rotation, such that the main body defines a minimum first wall thickness in the radial direction relative to the axis of rotation, and
the cam ring defines a minimum second wall thickness relative to the axis of rotation in the area of the cam track, wherein the first wall thickness is greater than the second wall thickness.

6. The hydrostatic rotary machine according to claim 1, wherein:
the first recesses each comprise a first section, which is circularly cylindrical with respect to a cylinder axis,
the first recesses are each open at a radially inner end,
each respective pin protrudes from the associated first recess at the radially inner end at which the associated first recess is open,
the cam ring abuts the main body with a press fit away from the first recesses,
the press fit extends in the direction of the axis of rotation over a first area,
the cam track extends in the direction of the axis of rotation over a second area, and
the first area is arranged entirely within the second area.

7. The hydrostatic rotary machine according to claim 1, wherein:
the first recesses each comprise a first section, which is circularly cylindrical with respect to a cylinder axis, such that the first section defines a first diameter,
the respective associated pin comprises a second section and a third section, which each at least partially abut the first section,
the second section is circularly cylindrical with respect to the cylinder axis and has a second diameter,
the third section is circularly cylindrical and has a third diameter relative to the cylinder axis, and
the second diameter is greater than the third diameter.

8. The hydrostatic rotary machine according to claim 7, wherein the third section is arranged radially further outward than the second section.

9. The hydrostatic rotary machine according to claim 8, wherein, in an area of the third section, a sealing ring is arranged between the pin and the respective associated first recess.

10. The hydrostatic rotary machine according to claim 7, wherein the second section is arranged radially further outward than the third section and the first recess intersects the main body radially to the axis of rotation.

11. The hydrostatic rotary machine according to claim 10, wherein the first recesses are each radially sealed on an outside by a separate flat seal, which is attached to the main body by a separate retaining plate.

12. The hydrostatic rotary machine according to claim 7, wherein:
either the second section or the third section projects radially inward over the main body, and
the respective groove has two opposite side walls, which are aligned parallel to the cylinder axis.

13. The hydrostatic rotary machine according to claim 1, wherein the cam ring is provided on the second end face with an annular extension relative to the axis of rotation and the cam track ends in the direction of the axis of rotation away from the extension.

14. The hydrostatic rotary machine according to claim 13, wherein a first outer diameter of the annular extension is greater than a second outer diameter of a remaining portion of the cam ring, and the main body is configured in an area of the first outer diameter at a distance to the cam ring.
